(19) United States
(12) Patent Application Publication
(10) Pub. No.: US 2026/0116419 A1
(43) Pub. Date: Apr. 30, 2026

(54) SYSTEMS AND METHODS FOR JOINT ALIGNMENT OF END-TO-END AUTONOMOUS DRIVING SYSTEMS AND FOUNDATION MODELS

(71) Applicant: Robert Bosch GmbH, Stuttgart (DE)

(72) Inventors: Abhirup Mallik, San Jose, CA (US); Yunsheng Ma, Sunnyvale, CA (US); Feng Tao, Cupertino, CA (US); Xin Ye, San Jose, CA (US); Chenbin Pan, Sunnyvale, CA (US); Burhaneddin Yaman, San Jose, CA (US); Liu Ren, Saratoga, CA (US)

(21) Appl. No.: 18/933,368

(22) Filed: Oct. 31, 2024

(51) Int. Cl. B60W 60/00; G06F 40/20; G06V 10/82; G06V 20/56

(52) U.S. Cl. CPC B60W 60/001; G06F 40/20; G06V 10/82; G06V 20/56; B60W 2420/403

(57) ABSTRACT

A system for training a drive system for an autonomous vehicle (AV) includes one or more computing devices configured to output a first drive plan and a second drive plan using an initial autonomous drive system (ADS) and an initial behavior foundation system (BFS). The computing devices is configured to generate a system-to-system (SS) loss between the initial ADS and the initial BFS using data from the respective system, and generate a module task loss for each system using respective drive plan and respective ground truth data. The computing devices is configured to adjust tunable parameters of the initial ADS and/or tunable parameters of the initial BFS to reduce a total loss provided by the SS loss and the module task loss. The initial ADS and/or the initial BFS is outputted as a trained drive system to be employed for the AV in response to the total loss being reduced.

### TECHNICAL FIELD

Aspects of this disclosure generally relate to a system for training models employed for controlling autonomous drive vehicles.

### BACKGROUND

The task of an autonomous driving system (ADS) is to process images and sensor inputs into control instructions for a vehicle to provide efficient driving in an autonomous manner. The ADS is specifically designed for automotive domain, by taking inspiration from traditional driving systems, and is trained using driving data (e.g., human driven data or a simulated driving data). Driving is a low latency task, and adding additional functionality, such as providing drive commentary to a user of the vehicle, can take away from the computing or processing bandwidth of the ADS.

### SUMMARY

In some aspects, the present disclosure is directed to a system for training a vehicle system for an autonomous vehicle using training image data and a combined loss. The system includes one or more computing devices configured to: define an initial autonomous drive system (ADS) to generate a first drive plan and an initial behavior foundation system (BFS) to generate a second drive plan; output, based on the training image data, the first drive plan and the second drive plan using the initial ADS and the initial BFS; generate a system-to-system (SS) loss between the initial ADS and the initial BFS by comparing selective data from the initial ADS to selective data from the initial BFS; generate a module task loss for each of the initial ADS and the initial BFS using the first drive plan, the second drive plan, and ground truth data for respective systems; adjusting, at least one of, a first set of tunable parameters of the initial ADS or a second set of tunable parameters of the initial BFS to reduce the combined loss provided by the SS loss and the module task loss; and output at least one of the initial ADS or the initial BFS as a trained system to be employed for an autonomous vehicle in response to the combined loss being reduced.

In some aspects, the present disclosure is directed to a non-transitory computer-readable medium comprising instructions for training a system for an autonomous vehicle, when executed by one or more hardware computing devices cause the one or more hardware computing devices to perform operations including to define an initial autonomous drive system (ADS) to generate a first drive plan, the initial ADS including a perception module, a prediction module, and a planning module; and define an initial behavior foundation system (BFS) to generate a second drive plan, the initial BFS including a trained behavior foundation model (FM), a visual question answering (VQA) module, and a FM plan module. The instructions further cause the one or more hardware computing devices to output the first drive plan and the second drive plan using the initial ADS, the initial BFS, and training image data, generate a contrastive loss between the initial ADS and the initial BFS using features extracted by the initial ADS and the initial BFS, generate a module task loss for each of the initial ADS and the initial BFS using the first drive plan, the second drive plan, and ground truth data for respective systems, adjust one or more ADS tunable parameters of the initial ADS and one or more BFS tunable parameters of the initial BFS to reduce a total loss provided by the contrastive loss and the module task loss, and output at least one of the initial ADS or the initial BFS as a trained system to be employed for an autonomous vehicle in response to the total loss being equal to or less than a loss threshold.

In some aspects, the present disclosure is directed to a method for training a system for an autonomous vehicle using training image data. The method includes outputting, using an initial autonomous drive system (ADS), a first drive plan using the training image data, where the initial ADS includes a perception module, a prediction module, and a planning module; outputting, using an initial behavior foundation system (BFS), a second drive plan using the training image data, where the initial BFS includes a trained behavior foundation model (FM), a visual question answering (VQA) module, and a FM plan module; generating a contrastive loss for at least one of the perception module, the prediction module, or the planning module using the trained behavior FM; generating a module task loss for at least one of the VQA module or the FM plan module and at least one of the perception module, the prediction module, or the planning module; adjusting, at least one of, a first set of tunable parameters of the initial ADS or a second set of tunable parameters of the initial BFS to reduce a total loss provided by the contrastive loss and the module task loss; and outputting at least one of the initial ADS or the initial BFS as a trained system to be employed for an autonomous vehicle in response to the total loss being equal to or less than a loss threshold.

### BRIEF DESCRIPTION OF THE DRAWINGS

FIG. 1 illustrates an autonomous vehicle having an autonomous drive system.

FIG. 2 illustrates an example block diagram of a joint training system in accordance with the present disclosure.

FIG. 3 illustrates an example block diagram of the initial ADS and the initial BFS as provided in the joint training system of FIG. 2.

FIG. 4 is a flowchart of an example joint training routine executed by the joint training system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

An ADS provides a modular end-to-end autonomous driving stack generally having a perception portion, a prediction portion, and a planning portion that, together, accomplish the task of autonomous driving. The ADS may lack explanation and reasoning capabilities.

Foundation model technology provide large language models trained on general purpose data that may be useful for various tasks providing reasoning and/or explanation. Foundation models, which are pretrained machine learning models trained on open world data, often involve language as one of the main modalities of the data. In foundation models, there is usually a connection between language and other modalities (e.g., video, vision, sensor data, among others). After pretraining, the foundation models may be adapted to a given task via fine-tuning. For autonomous driving domain, a behavior foundation system including a large language foundation model may still use more processing time than the ADS even after being fine-tuned.

In some aspects, the present disclosure is directed to a joint training system that aligns an ADS and a behavior foundation system (BFS) during training, and then the trained ADS and the trained BFS may be used together or separately during inference. As a non-limiting example, the joint training system of the present disclosure generates a system-to-system (SS) loss between an initial ADS and an initial BFS by comparing selective data from the initial ADS and from the initial BFS. As a non-limiting example, the SS loss is contrastive loss that detects loss between features extracted by the initial ADS and the initial BFS. The joint training system further determines a modular task loss for each of the initial ADS and the initial BFS using, for example, drive plans determined by the two systems. Based on the SS loss and the modular task loss, the joint training system is configured to adjust tunable parameters of at the initial ADS and/or the initial BFS to reduce the total loss, and output at least one of the initial ADS or the initial BFS as a trained system to be employed for an autonomous vehicle. Accordingly, the joint training system is configured to share the knowledge of the BFS with the ADS and vise versa to improve the explanation and reasoning capabilities of the ADS and latency and accuracy of the BFS in providing relevant contextual driving information.

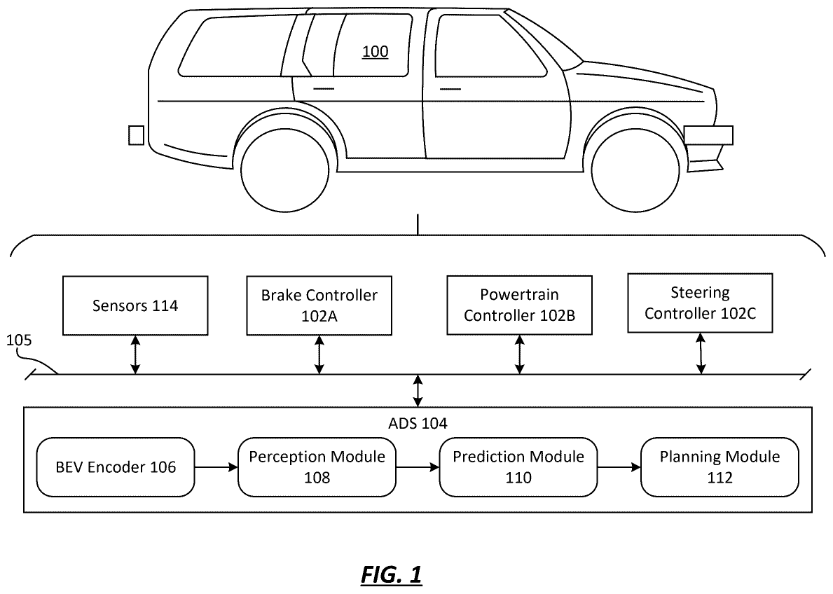

Referring to FIG. 1, an autonomous vehicle 100 includes a trained system for providing a drive plan used by various controllers 102A, 102B, 102C (collectively “controllers 102”) to control various functional operations of the AV 100. In a non-limiting example, the trained system is an autonomous drive system (ADS) 104, which is in communication with the controller 102 and other devices via a vehicle communication network 105. While specific controller 102 are provided, the AV 100 may include other controllers and should not be limited to the example provided herein.

In one form, the ADS 104 includes a bird's eye view (BEV) encoder 106, a perception module 108, a prediction module 110, and a planning module 112. While the ADS 104 is illustrated, other suitable trained systems may also be employed, such as a BFS system that is trained to output drive plans for the AV 100.

The BEV encoder 104 is configured to generate a BEV feature map (i.e., a “BEV”) of the AV 100 and its surrounding using images from one or more of the sensors 114 (e.g., camera, lidar, radar, among others). The BEV encoder 106 transforms multi-view features into the BEV that is a unified 2D representation from a top-down view and encapsulates perception details like object positions, lane markings, and road boundaries.

The perception module 108 is configured to interpret the surroundings of the AV 100 using the BEV to provide agent features (e.g., features of other objects about the AV 100). For instance, the perception module 108 detect objects or, also known as, agents (e.g., other vehicles, pedestrians, road lanes, traffic lights) and identify characteristics of the objects (e.g., distance, speed, type). The perception module 108 is configured to create real-time map of the AV 100, which is the ego-vehicle in the real-time map.

The prediction module 110 is configured to forecast or predict future states and trajectory of moving objects based on characteristics of the object provided in the real-time map. The forecasting may be done using models with contextual information (e.g., pedestrians crossing the street, vehicle changing lanes). Accordingly, the prediction module 110 generates multiple trajectories for each detected object.

The planning module 112 is configured to determine a drive plan for the AV 100 based on, at least, the real-time map and predicted future states. The drive plan provides a path that avoids interference with objects, adheres to traffic rules, and/or meets travel goal of the AV 100 (e.g., travel to a defined destination). In one form, the planning module 112 defines the drive plan as a sequence of waypoints that are translated into commands for other controllers, such as, the brake controller 102A, the powertrain controller 102B, and/or the steering controller 102C.

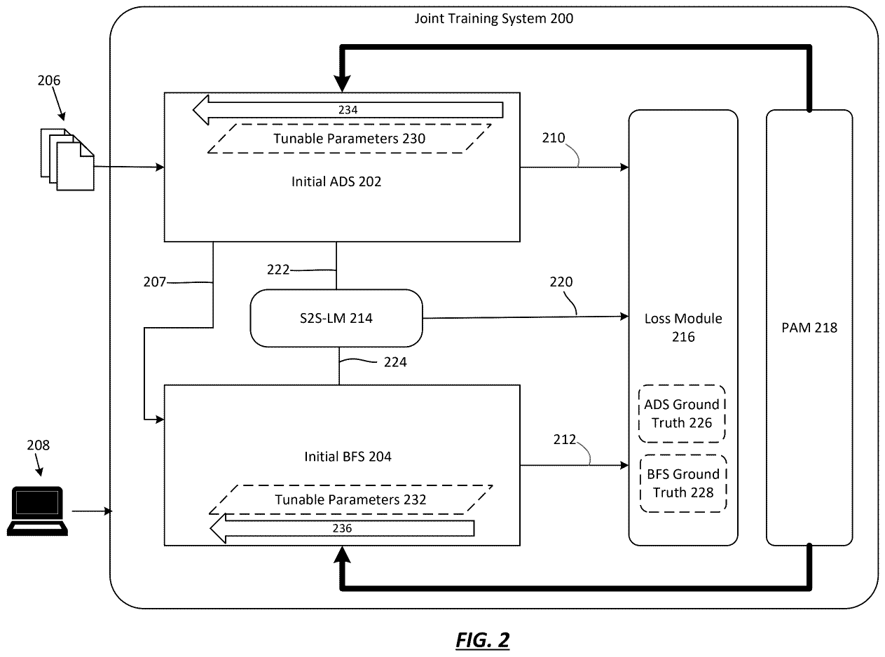

Referring to FIG. 2, in one form, an example joint training system 200 for training the ADS 104 is provided. That is, the joint training system 200 is configured to train an initial ADS 202 and an initial BFS 204 using training image data 206 that is provided to the initial ADS 202 to generate a BEV that is shared with the BFS 204 (represented by arrow 207). In some aspects, the joint training system 200 may also receive prompts from user using a computing device 208 in communication with the joint training system 200. In a non-limiting example, the initial ADS 202 and the initial BFS 204 are partially trained system that generate one or more ADS outputs 210 including an ADS drive plan 210 and one or more BFS outputs 212 including a FM drive plan 212.

In one form, the joint training system 200 includes a system-to-system learning module (S2S-LM) 214, a loss module 216, and a parameter adjustment module (PAM) 218. In some aspects, the joint training system 200 includes one or more hardware computing devices configured to perform the operations described herein, such as but not limited to, the operations of the S2S-LM 214, the loss module 216, and the PAM 218, and further supports and executes the initial ADS 202 and the initial BFS 204.

The S2S-LM 214 is configured to align internal representation between the initial ADS 202 and the initial BFS 204 using SS loss 220 by comparing selective data from the initial ADS 202 and from the initial BF 204. With the SS loss 220, the S2S-LM 214 is configured to reduce a distance between modules of the initial ADS 202 and of the BFS 204. In a nonlimiting example, the S2S-LM 214 is configured to align the ADS 202 and the BFS 204 using supervision loss (e.g., mean squared error of outputs from the initial ADS 202 and from the initial BF 204).

In another example, the S2S-LM 214 employs a contrastive learning technique provided in contrastive language image pretraining (CLIP), which is a vision-language foundation model trained on open world data using contrastive learning. Contrastive learning is a type of machine learning where the model learns to distinguish between positive and negative pairs of data. In the context of CLIP, the “positive pair” includes an image and a text description that are semantically related, while the “negative pair” includes an image and a randomly selected text description that is not related. During training, CLIP is configured to bring together features from related text and images pairs into a common embedding space, while pushing unrelated pairs apart. In CLIP, a dot product between batch of image and text features is performed to obtain the similarity between these vectors, which is defined as a matrix. A diagonal of the matrix provides paired image and text, and off-diagonals represent unpaired image and text features. During training, CLIP aims to increase the similarity of diagonal elements (i.e., positive pairs), while decreasing the similarity between off-diagonal elements.

Using the contrastive learning technique for the S2S-LM 214, features 222 extracted from one or more images (e.g., BEV 207) by encoders (not shown) of the initial ADS 202 are trained using features 224 extracted by the BFS 204, where the features 224 of the BFS 204 are representative of expected features for the initial ADS 202. The ground truth for a similarity matrix maybe a unit matrix that signifies each extracted feature 222 of the initial ADS 202 should be close to the corresponding expected extracted feature 224 of the BFS 204. Accordingly, the contrastive loss, as the SS loss 220, provided by the S2S-LM 214 indicates how accurate the initial ADS 202 is in identifying positive features and negative features. In the following, the SS loss 220 may be referenced to as a contrastive loss 220.

The loss module 216 is configured to generate one or more module task losses and determine a total loss (e.g., a combined loss) of the initial ADS 202 and the initial BFS 204 using the SS loss 220 and the module task losses. In one form, the loss module 216 generates the module task losses for each of the initial ADS 202 and the initial BFS 204. For example, the loss module 216 is configured to calculate a module task loss for the initial ADS 202 as a difference between the ADS outputs 210 and ground truth data associated with the ADS outputs 210 (e.g., ADS ground truth 226). Similarly, the loss module 216 is configured to calculate a module task loss for the initial BFS 204 as a difference between the BFS outputs 212 and ground truth data associated with the BFS outputs 212 (e.g., BFS ground truth 228). In some aspects, the ground truth for the ADS and the BFS may be human driving data and/or annotations. The total loss is then provided as a summation of the SS loss 220 and the module task losses.

The PAM 218 is configured to adjust tunable parameters 230 of the initial ADS 202 and/or tunable parameters 232 of the initial BFS 204 to reduce the total loss calculated by the loss module 216. For instance, as part of machine learning techniques, the PAM 218 is configured to backpropagate the total loss through the combined system of the initial ADS 202 and the initial BFS 204. In a non-limiting example, the tunable parameters 230, 232 are updated from end to beginning using some variant of gradient descent algorithm. Arrows 234 and 236 represent that backpropagation of the total loss.

With the total loss reduced (e.g., total loss is less than or equal to a loss threshold), the joint training system 200 may output at least one of the initial ADS 202 or the initial BFS 204 as a trained system to be employed for the autonomous vehicle. As a non-limiting example, one of the trained ADS 202 or the trained BFS 204 may be used as the ADS 104 to control the AV 100. In another example, the trained ADS 202 is employed as the ADS 104 to control the AV 100 and the trained BFS 204 provides drive commentary for users in the AV 100 and/or generates contextual information (e.g., labels and/or metadata tags) to be used by the trained ADS 202. During inference, the processing speed and accuracy of the ADS 202 and the reasoning capability of the BFS 204 may be retained by respective system and shared by the systems 202, 204.

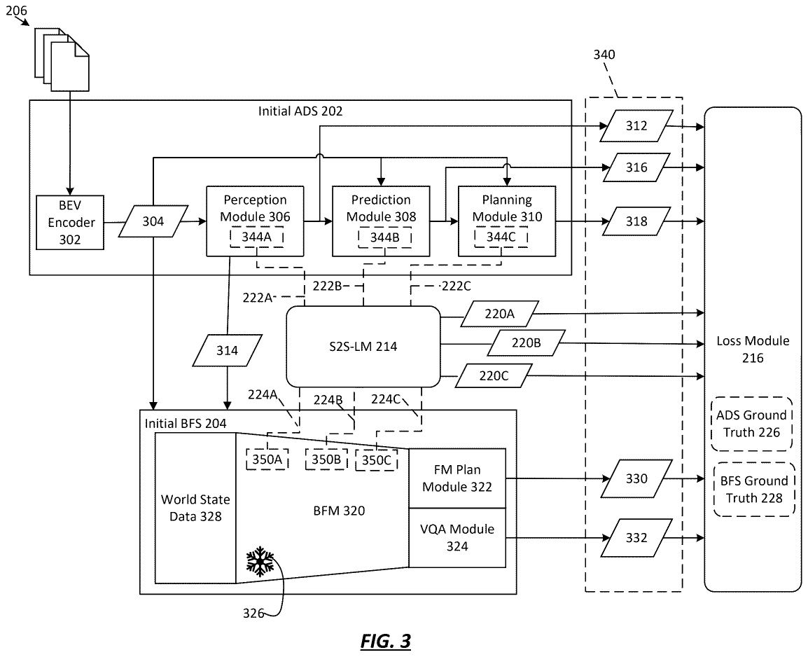

Referring to FIG. 3, the initial ADS 202 includes a BEV encoder 302, a perception module 306, a prediction module 308, and a planning module 310. The BEV encoder 304, the perception module 306, the prediction module 308, and the planning module 310 operate in a similar manner as that of the BEV encoder 106, the perception module 108, the prediction module 110, and the planning module 112 of the ADS 104. For instance, the BEV encoder 302 generates a BEV 304 using the training image data 206; the perception module 306 is configured to generate a real-time map (e.g., perception output 312) having behavior latent features (BLF) 314 that capture the dynamic interaction among agents (e.g. vehicles, cyclist, pedestrians); the prediction module 308 is configured to output predicted trajectories for detected objects (e.g., prediction output 316); and the planning module is configured to output the drive plan (e.g., planning output 318).

In one form, the outputs 312, 316, 318 by the perception module 306, the prediction module 308, and the planning module 310 are provided as the one or more ADS outputs 210 for determining a module task loss for each of the modules 306, 308, 310. In some aspects, the ADS output 210 may include outputs by at least one of the perception module 306, the prediction module 308, or the planning module 310 for determining the module task loss for the respective module.

As detailed herein, the joint training system 200 is configured to train or fine-tune the perception module 306, the prediction module 308, and/or the planning module 310 by adjusting the tunable parameters 230 of the ADS 202. For example, the tunable parameters 230 are associated with training at least one of the perception module 306, the prediction module 308, or the planning module 310 to reduce the total loss.

The initial BFS 204 is configured to include a behavior foundation module (BFM) 320, a plan module 322 (“FM plan module” hereinafter to distinguish from the planning module 310), and a visual question answering (VQA) module 324. The BFM 320 is a trained model, as indicated by symbol 326, and employs world state data 328 that includes information regarding ego-vehicle features, agent features (e.g., characteristics related to other objects or participants within the driving environment), and/or contextual features (e.g., scene descriptions), among other information. In some aspects, the BFM 320 analyzes the BEV 304 and the BLF 314 with the world state data 328 to, for example: detect and identify objects in surrounding environment provided by the BEV 304; provide characteristics of detected objects (e.g., distance, speed, heading of a moving object); and/or anticipate predicted paths of moving objects. The output by the BFM 320 may include contextual information and extracted features from images (e.g., features associated with detected objects provided in the BEV 304), where the contextual information is associated with the extracted features.

In some aspects, the FM plan module 322 is configured to generate and output a FM drive plan 330 for an AV, such as the AV 100. Generally, a plan modality provides a decision making and task execution modality to generate a sequence of steps for a given task by, for example, identifying constraints of the task, reducing the task into smaller actions, generating set of instructions for the smaller actions, and using contextual analysis to process a surrounding environment that is being dynamically updated. Here, the FM plan module 322 generates a sequence of steps for an AV to perform a drive maneuver. In a non-limiting example, the FM drive plan 330 is provided in the form of drive actions phrases (e.g., “change lane to left,” “merge into lane,” or “reduce speed to 30 mph”). The FM plan module 322 may use contextual based analysis from the BFM 320 to form the FM drive plan 330. The FM drive plan 330 may also be referred to as behavior primitives.

The VQA module 324 is configured to generate and output a contextual description/explanation 332 of image data provided by the BFM 320. Generally, a VQA modality for the BFM 320 employes natural language processing with computer vision to answer questions based on visual inputs (e.g., images). Here, the explanation 332 is contextual description related to the environmental surrounding of the AV, which is ultimately based on the BEV 304. As a non-limiting example, the explanation 332 includes “vehicle is traveling to left lane to take left at a traffic light,” “vehicle is decelerating to stop at the traffic light,” or “vehicle is merging to right lane to allow other vehicle to pass.”

In the following, the outputs 312, 314, 316, 330, and 332 may collectively be referred to as module outputs 340.

In some aspects, the S2S-LM 214 is configured to provide a SS loss 220A, 220B, 220C for the perception module 306, the prediction module 308, and the planning module 310, respectively. For instance, an encoder 344A of the perception module 306 extracts a feature 222A from an image (e.g., BEV 304) that is compared with a feature 224A extracted by the BFM 320. In some aspects, the BFM 320 is configured to include an adaptor 350A that is configured to provide the feature 224A for measuring the SS loss 220A associated with the perception module 306. Using known contrastive learning technique, the S2S-LM 214 determines the contrastive loss of the perception model 306 using the output of the BFM 320 as the ground truth.

The prediction module 308 and the planning module 310 are analyzed in a similar manner as that of the perception module 306. For instance, the prediction module 308 and the planning module 310 provide extracted features 222B, 222C via encoders 344B, 344C, respectively. In addition, the BFM 320 includes adaptors 350B, 350C that are configured to provide extracted features 224B, 224C for the determining the contrastive loss 220B, 220C for the prediction module 308 and the planning module 310.

While the SS loss 220 is described as being provided for each of the perception module 306, the prediction module 308, and the planning module 310, the initial ADS 202, the BFM 320, and the S2S-LM 214 may be configured to provide the SS loss 220 for one or more of the modules 306, 308, and/or 310.

In one form, the loss module 216 is configured to determine a module task loss for each output 340 using associated ground truth. In a non-limiting example, the loss module 216 calculates a modulate task loss for the VQA module 324, which may also be known as a text-generation loss, by comparing the output 332 of the VQA 324 with its associated ground truth provided in the BFS ground truth 228. While a module task loss is provided for each of the perception module 306, the prediction module 308, and the planning module 310 of the initial ADS system 202 and for each of the FM plan module 322 and the VQA module 324 of the initial BFS 204, the loss module 216 may be configured to output the module task loss for one or more of the modules 306, 308, 310, 322, 324.

In one form, the loss module 216 determines the total loss by taking into account the SS loss 220 and the module task losses (e.g., taking a summation of the losses). In some aspects, the loss module 216 may determine a total module task loss for the perception module 306, the prediction module 308, and/or the planning module 310, but taking a summation of the respective SS loss 220 and respective module task loss for each module 306, 308, 310.

While not illustrated in FIG. 3 for brevity, the PAM 218 backpropagates the loss through the initial ADS and the initial BFS 204 to improve the accuracy of the perception module 306, the prediction module 308, and the planning module 310 of the initial ADS system 202 and the FM plan module 322 and the VQA module 324 of the initial BFS 204.

The joint training system 200 of the present disclosure is configured to train an ADS and a BFS at the same time to transfer knowledge between the two systems. For example, the ADS may obtain reasoning and explanation capability of the BFS while maintaining its processing speed. On the other hand, the BFS may increase its processing speed while maintaining its reasoning and explanation capability.

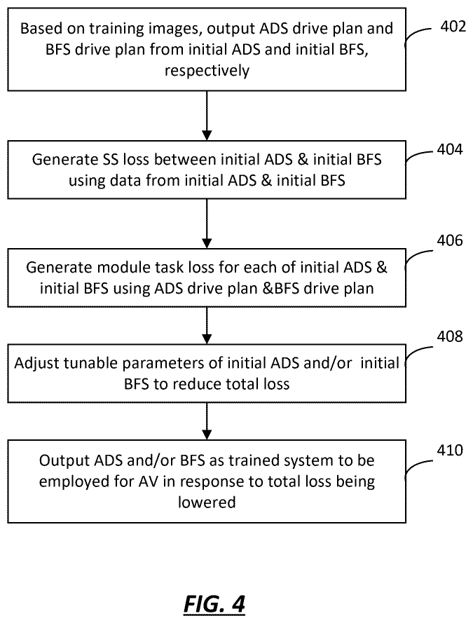

Referring to FIG. 4, an example joint training routine 400 is provided and executed by the joint training system 200.

At operation 402, the joint training system 200 outputs an ADS drive plan and a BFS drive plan from the initial ADS 202 and the initial BFS based on the training images 206. For example, the BEV encoder 302 generates the BEV 304 using the training images 206 and the BEV 304 is used by the initial ADS 202 and the initial BFS 204 to generate the drive plans 210, 212 (e.g., outputs 318, 330 of FIG. 3).

At operation 404, the joint training system 200 is configured to generate SS loss 220 between initial ADS 202 and the initial BFS 204 using data from the initial ADS 202 and the initial BFS 204. In a non-limiting example, the SS loss 220 is provided as contrastive loss that is provided using features extracted by the initial ADS 202 and the initial BFS 204. In some variations, the SS loss is generated for at least one of the perception module 306, the prediction module 308, and/or the planning module 310, as described above.

At operation 406, the joint training system 200 is configured to generate a module task loss for each of the initial ADS 202 and the initial BFS 204 using the drive plans 210, 212 (e.g., outputs 318, 330 of FIG. 3), and ground truth data for respective systems 202, 204. In some variations, the module task loss may be determined for the perception module 306, the prediction module 308, and/or the VQA module 324, as described above.

At operation 408, the joint training system 200 is configured to adjust tunable parameters 230, 232 of the initial ADS 202 and/or the initial BFS 204 to reduce total loss, which is provided by the SS loss 220 and the module task loss, as detailed above.

At operation 410, the joint training system 200 is configured to output ADS and/or BFS as trained system to be employed for the AV 100 in response to total loss being lowered. For example, the trained system may be outputted when the total loss is less than or equal to a loss threshold.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In a non-limiting example, the ADS 104 (including the BEV encoder 106, the perception module 108, the prediction module 110, the planning module 112), the controllers, 102, and/or the joint training system 200 with the initial ADS 202 (including BEV encoder 302, perception module 306, prediction module 308, planning module), the BFS 204 (including world state data 328, the BFM 320, the FM plan module 322, the VQA module 324), the S2S-LM 214, the loss module 216, and the PAM 218 may include: a hardware computing device, an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory or memory circuit may be a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (e.g., an analog or digital magnetic tape or a hard disk drive), and optical storage media (e.g., a USB, CD, a DVD, or a Blu-ray Disc).

The ADS system 102, the controllers 102, and/or the joint training system 200 described in this application may be partially or fully implemented by a special purpose computer created by configuring a general-purpose computer to execute one or more particular functions embodied in computer programs. Components employed for the joint training system 200 may be provided in a single device or may be distributed among multiple devices that are in communication using wireless communication (e.g., cellular network, WiFi network, BLUETOOTH, among others) and/or wired communication.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for training a vehicle system for an autonomous vehicle using training image data and a combined loss, comprising:
one or more computing devices configured to:
define an initial autonomous drive system (ADS) to generate a first drive plan and an initial behavior foundation system (BFS) to generate a second drive plan;
output, based on the training image data, the first drive plan and the second drive plan using the initial ADS and the initial BFS;
generate a system-to-system (SS) loss between the initial ADS and the initial BFS by comparing selective data from the initial ADS to selective data from the initial BFS;
generate a module task loss for each of the initial ADS and the initial BFS using the first drive plan, the second drive plan, and ground truth data for respective systems;
adjusting, at least one of, a first set of tunable parameters of the initial ADS or a second set of tunable parameters of the initial BFS to reduce the combined loss provided by the SS loss and the module task loss; and
output at least one of the initial ADS or the initial BFS as a trained system to be employed for an autonomous vehicle in response to the combined loss being reduced.

2. The system of claim 1, wherein:
the initial ADS is defined to include a bird's eye view (BEV) encoder configured to generate a BEV image data using the training image data, and
the first drive plan and the second drive plan are outputted using the BEV image data.

3. The system of claim 1, wherein the at least one of the initial ADS or the initial BFS is outputted as the trained system in response to the combined loss being equal to or less than a loss threshold.

4. The system of claim 1, wherein:
the initial ADS is defined to include a perception module, a prediction module, and a planning module, and
the initial BFS is defined to include a trained behavior foundation model (FM), a visual question answering (VQA) module, and a FM plan module.

5. The system of claim 4, wherein:
the first set of tunable parameters are associated with at least one of the perception module, the prediction module, or the planning module, and
the second set of tunable parameters are associated with at least one of the VQA module or the FM plan module.

6. The system of claim 4, wherein the one or more computing devices is configured to compare features extracted from the at least one of the perception module, the prediction module, or the planning module to features extracted by the trained behavior FM to generate a contrastive loss as the SS loss.

7. The system of claim 6, wherein, the contrastive loss is generated for each of the perception module, the prediction module, and the planning module.

8. The system of claim 4, wherein the one or more computing devices is configured to generate one or more behavior latent features identified by the perception module, wherein the first drive plan and the second drive plan are outputted using the one or more behavior latent features.

9. The system of claim 4, wherein:
the module task loss of the initial ADS includes a task loss for the planning module that outputs the first drive plan, and a task loss for at least one of the perception module or the projection module using output of the at least one perception module or the projection module, and
the module task loss of the initial BFS includes a task loss for the FM plan module that outputs the second drive plan and the VQA module based on an output of the VQA module.

10. A non-transitory computer-readable medium comprising instructions for training a system for an autonomous vehicle, when executed by one or more hardware computing devices cause the one or more hardware computing devices to perform operations including to:
define an initial autonomous drive system (ADS) to generate a first drive plan, the initial ADS including a perception module, a prediction module, and a planning module,
define an initial behavior foundation system (BFS) to generate a second drive plan, the initial BFS including a trained behavior foundation model (FM), a visual question answering (VQA) module, and a FM plan module,
output the first drive plan and the second drive plan using the initial ADS, the initial BFS, and training image data,
generate a contrastive loss between the initial ADS and the initial BFS using features extracted by the initial ADS and the initial BFS,
generate a module task loss for each of the initial ADS and the initial BFS using the first drive plan, the second drive plan, and ground truth data for respective systems,
adjust one or more ADS tunable parameters of the initial ADS and one or more BFS tunable parameters of the initial BFS to reduce a total loss provided by the contrastive loss and the module task loss, and
output at least one of the initial ADS or the initial BFS as a trained system to be employed for an autonomous vehicle in response to the combined loss being equal to or less than a loss threshold.

11. The non-transitory computer-readable medium of claim 10, wherein:
the initial ADS is defined to include a bird's eye view (BEV) encoder configured to generate a BEV image data using the training image data, and
the first drive plan and the second drive plan are outputted using the BEV image data.

12. The non-transitory computer-readable medium of claim 10, wherein:
the one or more ADS tunable parameters are associated with the perception module, the prediction module, and the planning module, and
the one or more BFS tunable parameters are associated with the VQA module and the FM plan module.

13. The non-transitory computer-readable medium of claim 10, wherein, for the contrastive loss, the instructions further cause the one or more hardware computing devices to compare features extracted from the at least one of the perception module, the prediction module, or the planning module to features extracted by the trained behavior FM.

14. The non-transitory computer-readable medium of claim 13, wherein, the contrastive loss is generated for each of the perception module, the prediction module, and the planning module.

15. The non-transitory computer-readable medium of claim 10, wherein the instructions further cause the one or more hardware computing devices to generate one or more behavior latent features identified by the perception module, wherein the first drive plan and the second drive plan are outputted using the one or more behavior latent features.

16. The non-transitory computer-readable medium of claim 10, wherein:
the module task loss of the initial ADS includes a task loss for the planning module that outputs the first drive plan, and a task loss for each of the perception module and the projection module using outputs of the perception module and the projection module, and
the module task loss of the initial BFS includes a task loss for the FM plan module that outputs the second drive plan and the VQA module based on an output of the VQA module.

17. A method for training a system for an autonomous vehicle using training image data, comprising:
outputting, using an initial autonomous drive system (ADS), a first drive plan using the training image data, the initial ADS including a perception module, a prediction module, and a planning module;
outputting, using an initial behavior foundation system (BFS), a second drive plan using the training image data, the initial BFS including a trained behavior foundation model (FM), a visual question answering (VQA) module, and a FM plan module;
generating a contrastive loss for at least one of the perception module, the prediction module, or the planning module using the trained behavior FM;
generating a module task loss for at least one of the VQA module or the FM plan module and at least one of the perception module, the prediction module, or the planning module;
adjusting, at least one of, a first set of tunable parameters of the initial ADS or a second set of tunable parameters of the initial BFS to reduce a total loss provided by the contrastive loss and the module task loss; and
outputting at least one of the initial ADS or the initial BFS as a trained system to be employed for an autonomous vehicle in response to the total loss being equal to or less than a loss threshold.

18. The method of claim 17, wherein the initial ADS further includes a bird's eye view (BEV) encoder configured to generate a BEV image data using the training image data, and the first drive plan and the second drive plan are outputted using the BEV image data.

19. The method of claim 17, further comprising generating one or more behavior latent features identified by the perception module, wherein the first drive plan and the second drive plan are outputted using the one or more behavior latent features.

20. The method of claim 17, wherein:
the module task loss of the initial ADS includes a task loss each of the perception module, the prediction module, and the planning module, and
the module task loss of the initial BFS includes a task loss for each of the VQA module or the FM plan module.
